(19) United States
(12) Patent Application Publication
(10) Pub. No.: US 2008/0215807 A1
(43) Pub. Date: Sep. 4, 2008

(54) VIDEO DATA SYSTEM

(75) Inventor: Yosuke Muraki, Campbell, CA (US)

Correspondence Address: LAW OFFICES OF MIKIO ISHIMARU, 333 W. EL CAMINO REAL, SUITE 330, SUNNYVALE, CA, 94087, US

(73) Assignees: SONY CORPORATION, Tokyo (JP); SONY ELECTRONICS INC., Park Ridge, NJ (US)

(21) Appl. No.: 11/681,611

(22) Filed: Mar. 2, 2007

(51) Int. Cl. G06F 12/00

(52) U.S. Cl. 711/113

(57) ABSTRACT

A video data system is presented including buffering video data for a display device, preserving the video data in a non-volatile video random access memory during shutdown of the display device, and restoring the video data to the display device on power-up of the display device.

### TECHNICAL FIELD

The present invention relates generally to electronic system memory control, and more particularly to a system for managing video data in electronic systems.

### BACKGROUND ART

The presentation of video information is pervasive today. All of the communication modes have included a video aspect. Telephones not only manage voice communication, but have cameras, video recorders and can display streaming video from the internet. Computer systems have moved into the video and communication realms also. The internet has enabled a global reach for computer systems and streaming video is available on a cell phone.

Many systems have software support for recovering from power loss or some other type of system failure. Several commercial software applications sprang up from the need for recovery processes. Operating systems utilize non-volatile magnetic media as a temporary storage facility and swap space known as virtual memory. In computers, the basic input/output system (BIOS) is stored in non-volatile “flash memory”. The flash memory protects the data and preserves the function during system power up and power down.

Video systems have found their way into diagnostic equipment for machines and people. Logic analyzers may be used to diagnose a digital circuit as an Electro-Cardiograph is used to diagnose the human heart. Preservation of the video data can have a significant impact on the health and capabilities of both.

The operating system of a computer may use restoration pointers to keep track of the procedures that it is running. In case of an unplanned system shut-down, the restoration pointers are used to return the hardware configuration to a condition very near the time of the incident. The restoration pointers are saved on non-volatile magnetic media, such as a disk drive.

During a shutdown, whether planned or unplanned, recovery software copies key information from the system memory to the disk drive. Applications, such as publishing software, word processors, spreadsheet, and database programs, perform periodic saving operations. These saving operations write an image of the current contents of the file being manipulated to the disk drive, in case there is an unplanned system shutdown. This pervasive strategy has not found a reasonable method to preserve the content of the video display.

DVD movies have a scene select feature, so that an end user doesn't have to watch the entire movie to pick-up where the system shut down. In all cases the user has to be protected from the potential loss of data, whether it is from data manipulation applications or a DVD movie. The additional software creates overhead that consumes the processor cycles just to have a recovery mechanism, whether it is needed or not.

In the case of video data, the only option available today is to retrace the video data that has already been viewed. Though these problems occur on a daily basis, they have not been directly addressed. Due to the difficulty in defining a robust solution, manufacturers of the communication equipment have chosen to rely on recovery processes that are added on or that reduce the efficiency of the products.

Thus, a need still remains for a video data system that can manage unexpected disruptions without constantly inducing inefficiencies in the systems in order to be prepared. In view of the consumer demand for more efficient systems and the critical nature of some of the video data, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to save costs, improve efficiencies and performance, and meet competitive pressures, adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a video data system including buffering video data for a display device, preserving the video data in a non-volatile video random access memory during shutdown of the display device, and restoring the video data to the display device on power-up of the display device.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a block diagram of a video data system, in an embodiment of the present invention;

FIG. 2 is a functional block diagram of the non-volatile video random access memory, in a further embodiment of the present invention;

FIG. 3 is a block diagram of a video data system, in an alternative embodiment of the present invention;

FIG. 4 is applications for the video data system, as an embodiment of the present invention;

FIG. 5 is a block diagram of a video data system, in an alternative embodiment of the present invention; and

FIG. 6 is a flow chart of a video data system for manufacturing the video data system in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. Where multiple embodiments are disclosed and described, having some features in common, for clarity and ease of illustration, description, and comprehension thereof, similar and like features one to another will ordinarily be described with like reference numerals.

For expository purposes, the term “on” means there is direct contact among elements. The term “system” as used herein means and refers to the method and to the apparatus of the present invention in accordance with the context in which the term is used.

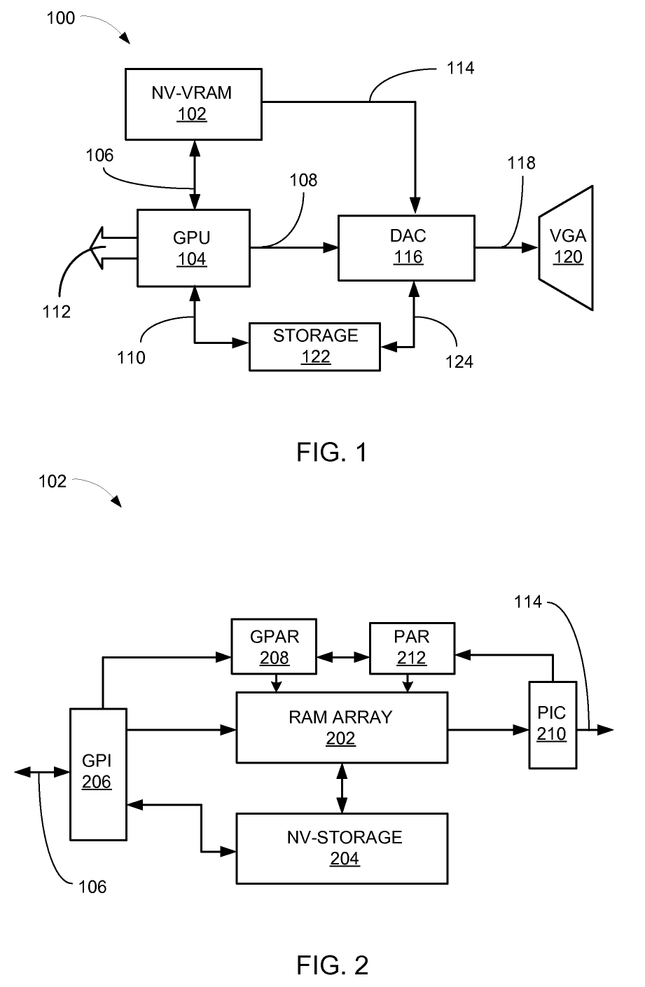

Referring now to FIG. 1, therein is shown a block diagram of a video data system 100, in an embodiment of the present invention. The block diagram of the video data system 100 depicts a non-volatile video random access memory (NV-VRAM) 102 coupled to a graphics processing unit (GPU) 104 having a graphics memory interface 106, a memory picture interface 108, a video basic input/output system (VBIOS) interface 110, and a central processing unit (CPU) interface 112. The graphics memory interface 106 couples the NV-VRAM 102 to the GPU 104, for buffering successive screens of video data. The NV-VRAM 102 has a picture interface 114 coupled to a digital to analog converter (DAC) 116.

The GPU 104 pre-conditions the DAC 116 to process the signals from the picture interface 114. The DAC 116 generates an analog signal 118 required to drive a video graphics array (VGA) connector 120. The VGA connector 120 may be coupled to a display device (not shown) for presenting the video data.

A storage chip 122, such as a flash memory chip having the video basic input/output system, may be coupled to the GPU 104 and the DAC 116 in order to provide power on initialization information to set-up both devices when voltage is first applied and becomes stable. The storage chip 122 is a non-volatile memory device that may be programmed with the information required to activate features within the GPU 104 and the DAC 116. A digital to analog converter set-up interface 124 couples the DAC 116 to the storage chip 122.

Upon power-up the GPU 104 retrieves initialization from the storage chip 122. The GPU may also assist in initializing the DAC 116. The GPU 104 will communicate through the CPU interface 112 to the system controller (not shown) to pass initialization status and possibly recovery information, in the event of an unplanned shutdown. In some applications of the video data system 100, such as a medical monitor or electrocardiogram (EKG), restoring the last data stream can be very important. In a system without the video data system 100, an unexpected power loss or processor shutdown could disrupt the presentation of the data and possibly lose the data all together.

The NV-VRAM 102 has the capability of retaining the last presented data stream for re-display. This feature may be accessed by the GPU 104 in order to present the data through the DAC 116 and the VGA connector 120, or it may be presented through the CPU interface for other system applications.

Referring now to FIG. 2, therein is shown a functional block diagram of the non-volatile video random access memory 102, in a further embodiment of the present invention. The functional block diagram of the non-volatile video random access memory 102 depicts a volatile memory array 202, such as a random access memory (RAM) array or a dynamic random access memory (DRAM) array, with a non-volatile storage (NV-Storage) 204 that is closely coupled. The non-volatile storage 204 may share the same silicon substrate as the volatile memory array 202, or it may reside within the same package. The non-volatile storage 204 may be an array of flash memory cells, a CMOS memory array, or the like. A graphics processor interface (GPI) 206 manages the movement of data between the volatile memory array 202 and the non-volatile storage 204. A graphics processor address register (GPAR) 208 is used to access the volatile memory array 202 to store the video data from the graphics processor interface 206.

The volatile memory array 202, such as a dual port random access memory array, operates in a dual port configuration. The secondary port supplies data to a picture interface controller (PIC) 210 and is supported by a picture address register (PAR) 212. The dual port action of the volatile memory array 202 provides a streaming data path to support the picture interface 114.

In one embodiment of the present invention, a signal from the graphics processor interface 206 may cause an immediate transfer of all of the bits in the volatile memory array 202 to the corresponding bits within the non-volatile storage 204. Based on the close coupling of the two arrays very little time is required to complete the transfer. The signal from the graphics processor interface 206 may represent a power failure warning or a shutdown command received through the graphics memory interface 106. In either case a current video data stream is transferred from the volatile memory array 202 to the non-volatile storage 204.

On power-up or initialization the graphics processor interface may cause the restoration of the data from the non-volatile storage 204 to the volatile memory array 202. The graphics processor interface 206 may alternatively transfer the data held in the non-volatile storage 204 across the graphics memory interface 106. The restoration of the data to the volatile memory array 202, allows the GPU 104 of FIG. 1 to activate the DAC 116 of FIG. 1 to initiate the display of the data. This represents an immediate data recovery process without causing additional CPU cycles to be consumed on transferring data from a disk or completely losing the data, which would cause the data to have to be recaptured.

The functional block diagram of the non-volatile video random access memory 102 depicts the non-volatile storage 204 as a separate block from the volatile memory array 202, but it is understood that this is an example only and the bits of the non-volatile storage 204 may be individually adjacent to the bits of the volatile memory array 202. It is further understood that while the graphics processor address register 208 and the picture address register 212 are shown as two separate elements they may be multiplexed into a single address bus for both the volatile memory array 202 and the non-volatile storage 204.

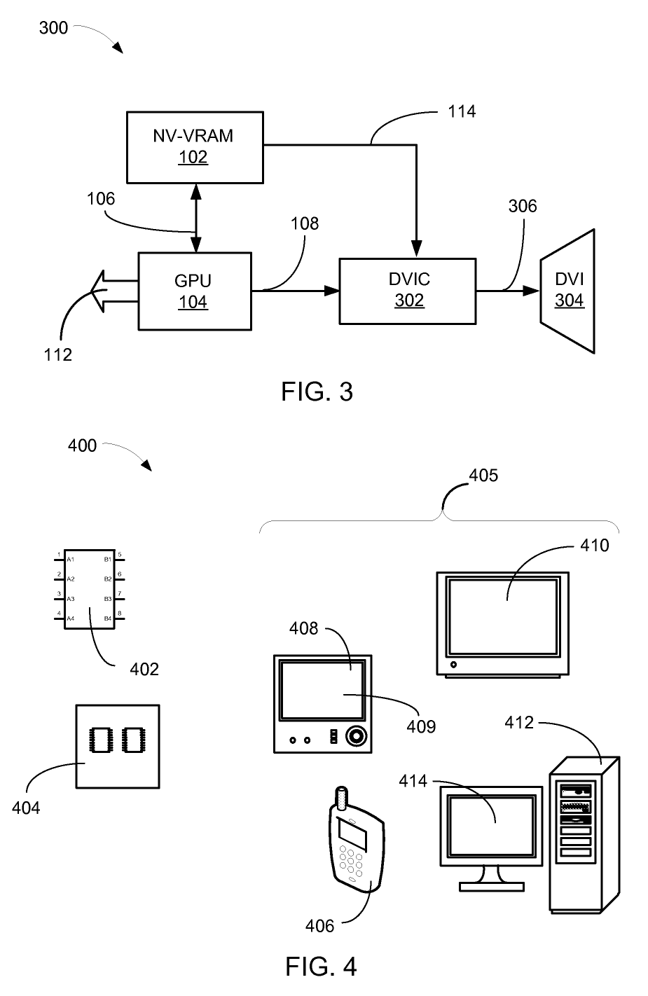

Referring now to FIG. 3, therein is shown a block diagram of a video data system 300, in an alternative embodiment of the present invention. The a block diagram of the video data system 300 depicts the NV-VRAM 102 coupled to the GPU 104 having the graphics memory interface 106, the memory picture interface 108, and the central processing unit (CPU) interface 112. The graphics memory interface 106 couples the NV-VRAM 102 to the GPU 104, for transferring successive screens of the video data. The NV-VRAM 102 has the picture interface 114 coupled to a digital video interface controller (DVIC) 302. The DVIC 302 is coupled to a digital video interface (DVI) 304 by a digital interface bus 306.

This configuration also demonstrates using the NV-VRAM 102 to store the video basic input/output system (VBIOS) information. This system operational information may be stored in a reserved area of the non-volatile storage 204 of FIG. 2. On power-up, the GPU 104 may access the graphics memory interface 106 to retrieve the initialization information. As described above, the GPU 104 pre-conditions the DVIC 302 to process the signals from the picture interface 114. The DVIC 302 generates the signals, for the digital interface bus 306, required to drive the digital video interface 304. The digital video interface 304 may be coupled to a display device (not shown) for presenting the video data.

It has been unexpectedly discovered that by utilizing the NV-VRAM 102 in the aforementioned fashion the design of the video data system 300 may be simplified. The CPU interface 112, the memory picture interface 108, and the picture interface 114 operate as previously defined. In the above described configuration, the GPU 104 may access the video basic input/output system (VBIOS) information through the graphics memory interface 106 rather than the video basic input/output system (VBIOS) interface 110, of FIG. 1.

Referring now to FIG. 4, therein is shown applications 400 for the video data system 100, as an embodiment of the present invention. The applications for the video data system include an integrated circuit 402, a printed circuit board 404, or an electronic video system 405, such as a cell phone 406, a tester 408 having a video data 409, a television 410, or a computer system 412. The computer system 412 copies the video data 409 to a display device 414, such as a liquid crystal display (LCD) monitor, a cathode ray tube (CRT), a video projector, or the like. By using the video data system 100, the electronic video system 405 may recover from an unexpected shutdown, while preserving the data stream that was last displayed without additional overhead to the system CPU.

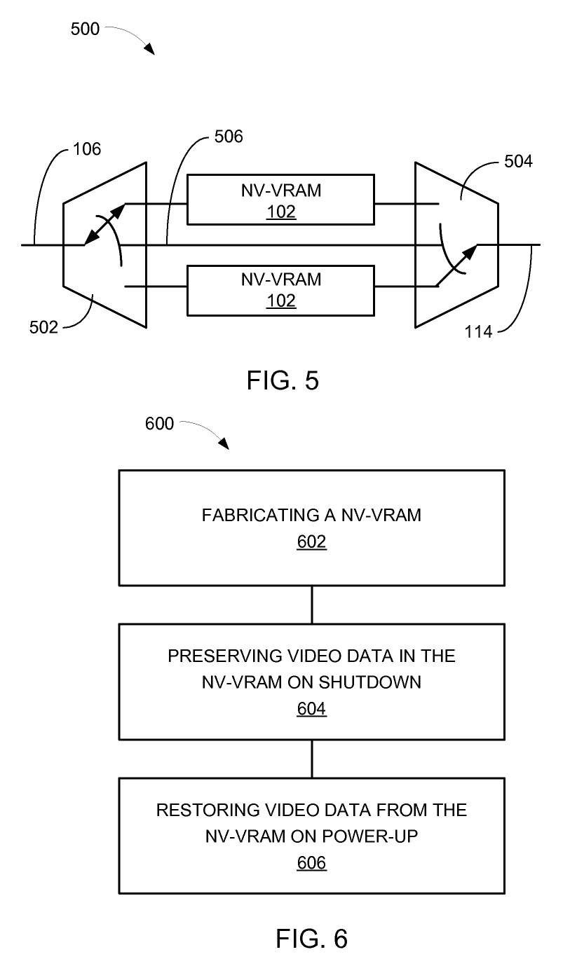

Referring now to FIG. 5, therein is shown a block diagram of a video data system 500, in an alternative embodiment of the present invention. The block diagram of the video data system 500 depicts an input switch 502, such as a bidirectional intelligent switch, coupled to a first instance and a second instance of the non-volatile video random access memory 102. The output of the first instance and the second instance of the non-volatile video random access memory 102 is coupled to an output switch 504, such as a multi-pole single throw switch. The input switch 502 and the output switch 504 are linked by an intelligent linkage 506.

The intelligent linkage 506 manages the switching of the input switch 502 and the output switch 504, such that when the first instance of the non-volatile video random access memory 102 has been filled from the graphics memory interface 106 the input switch 502 enables the intelligent linkage 506 for switching the output switch 504 to select the first instance of the non-volatile video random access memory 102 for reading to the picture interface 114. While the first instance of the non-volatile video random access memory 102 is read to the picture interface 114, the input switch 502 has selected the second instance of the non-volatile video random access memory 102 to be filled from the graphics memory interface 106.

If the second instance of the non-volatile video random access memory 102 is filled prior to the first instance of the non-volatile video random access memory 102 being emptied, the intelligent linkage 506 holds the input switch 502 until the first instance of the non-volatile video random access memory 102 is available to be filled. When the read of the first instance of the non-volatile video random access memory 102 has completed the intelligent linkage 506 allows both the output switch 504 and the input switch 502 to switch to the appropriate instance of the non-volatile video random access memory 102.

By way of example, the video data system 500 is shown having two instances of the non-volatile video random access memory 102, such as frame buffers, but it is understood that the video data system 500 may have any number of the frame buffers required to meet system performance. The operation of the intelligent linkage 506 may have other features, such as power-up initialization and last frame buffer select, which are not fully described. These features allow the processor to read the video basic input/output system on power-up and select the last frame buffer that was displayed prior to a shut down, respectively.

Referring now to FIG. 6, therein is shown a flow chart of a video data system 600 for manufacturing the video data system 100 in an embodiment of the present invention. The system 500 includes buffering video data for a display device in a block 602; preserving the video data in a non-volatile video random access memory during shutdown of the display device in a block 604; and restoring the video data to the display device on power-up of the display device in a block 606.

In greater detail, a video data system to recover and display the video data after a shutdown, according to an embodiment of the present invention, is performed as follows:
1. Providing a graphics processor unit having a graphics memory interface. (FIG. 1)
2. Coupling a non-volatile video random access memory to the graphics processing unit including coupling the non-volatile video random access memory to the graphics memory interface. (FIG. 1)
3. Preserving a video data during a shutdown including saving the video data in the non-volatile video random access memory. (FIG. 1) and
4. Restoring the video data from the non-volatile video random access memory on power-up including copying the video data by a graphics processor interface. (FIG. 1)

It has been discovered that the embodiments of the present invention thus have numerous aspects.

A principle aspect of the embodiments of the present invention is the ability to recover the video data that was displayed at the time of a shutdown without the use of additional CPU overhead or delays while the data is recovered from the disk drive.

Another aspect of the embodiments is that the system may be simplified by loading the video basic input/output system into the non-volatile video random access memory, thus reducing the number of interface lines and removing a separate storage function.

Yet another important aspect of the embodiments of the present invention is that it valuably supports and services the historical trend of reducing costs, simplifying systems, and increasing performance.

These and other valuable aspects of the embodiments of the present invention consequently further the state of the technology to at least the next level.

Thus, it has been discovered that the video data system of the present invention furnishes important and heretofore unknown and unavailable solutions, capabilities, and functional aspects for recovering the video data after a shutdown. The resulting processes and configurations are straightforward, cost-effective, uncomplicated, highly versatile and effective, can be surprisingly and unobviously implemented by adapting known technologies, and are thus readily suited for efficiently and economically manufacturing video data system devices fully compatible with conventional manufacturing processes and technologies. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A video data system comprising:
buffering video data for a display device;
preserving the video data in a non-volatile video random access memory during shutdown of the display device; and
restoring the video data to the display device on power-up of the display device.

2. The system as claimed in claim 1 further comprising reading a video basic input/output system from the non-volatile video random access memory.

3. The system as claimed in claim 1 wherein preserving the video data includes copying the video data from a volatile memory array of the non-volatile video random access memory to a non-volatile storage of the non-volatile video random access memory.

4. The system as claimed in claim 1 wherein restoring the video data to the display device includes:
reading the video data from a non-volatile storage of the non-volatile video random access memory; and
copying the video data from the non-volatile storage to a volatile memory array of the non-volatile video random access memory.

5. The system as claimed in claim 1 wherein restoring the video data to the display device by restoring a video basic input/output system from the non-volatile video random access memory (102) before restoring the video data.

6. A video data system comprising:
providing a graphics processor unit;
buffering video data for a display device by the graphics processor unit;
preserving the video data in a non-volatile video random access memory during shutdown of the display device; and
restoring the video data to the display device on power-up of the display device.

7. The system as claimed in claim 6 further comprising reading a video basic input/output system from the non-volatile video random access memory for initializing the graphics processor unit.

8. The system as claimed in claim 6 wherein preserving the video data includes:
buffering the video data in a dual port volatile memory array of the non-volatile video random access memory;
receiving a signal preceding a shutdown; and
copying the video data from the dual port volatile memory array to a non-volatile storage of the non-volatile video random access memory based on the signal.

9. The system as claimed in claim 6 wherein restoring the video data to the display device includes:
reading a video basic input/output system from the non-volatile video random access memory for initializing the graphics processor unit; and
copying the video data from a non-volatile storage of the non-volatile video random access memory to a volatile memory array of the non-volatile video random access memory including copying the video data to the graphics processor unit, the volatile memory array, or a combination thereof.

10. The system as claimed in claim 6 further comprising providing a picture interface controller in the non-volatile video random access memory for transferring the video data to a display device.

11. A video data system comprising:
a processor;
a non-volatile video random access memory coupled to the processor for buffering video data from the processor; and
a display device coupled to the non-volatile video random access memory for preserving the video data on shutdown of the display device and restoring the video data on power-up of the display device.

12. The system as claimed in claim 11 wherein the non-volatile video random access memory includes a video basic input/output system.

13. The system as claimed in claim 11 wherein the non-volatile video random access memory includes:
a volatile memory array for buffering the video data; and
a non-volatile storage coupled to the volatile memory array for copying the video data on shutdown.

14. The system as claimed in claim 11 wherein the non-volatile video random access memory includes:
a volatile memory array of the non-volatile video random access memory for buffering the video data; and
a non-volatile storage coupled to the volatile memory array for preserving the video data during a shutdown of the display device.

15. The system as claimed in claim 11 wherein the non-volatile video random access memory includes:
a non-volatile storage of the non-volatile video random access memory for restoring the video data; and
a volatile memory array coupled to the non-volatile storage for buffering the video data restored from the non-volatile storage.

16. The system as claimed in claim 11 wherein the processor coupled to the non-volatile video random access memory for buffering the video data includes the processor writing the video data in the non-volatile video random access memory and the display device reading the video data from the non-volatile video random access memory concurrently.

17. The system as claimed in claim 16 further comprising a video basic input/output system in the non-volatile video random access memory for initializing the processor on power-up.

18. The system as claimed in claim 16 wherein the non-volatile video random access memory includes:
a volatile memory array of the non-volatile video random access memory coupled to the processor for buffering the video data; and
a non-volatile storage closely coupled to the volatile memory array for saving the video data, written by the processor, during a shutdown.

19. The system as claimed in claim 16 wherein the non-volatile video random access memory includes:
a volatile memory array of the non-volatile video random access memory for buffering the video data; and
a non-volatile storage coupled to the volatile memory array for preserving the video data during a shutdown of the display device by the video data copied from the volatile memory array to the non-volatile storage.

20. The system as claimed in claim 16 wherein the non-volatile video random access memory includes:
a non-volatile storage of the non-volatile video random access memory for restoring the video data by the video data copied from the non-volatile storage to a volatile memory array; and
the volatile memory array coupled to the non-volatile storage for buffering the video data restored from the non-volatile storage for transferring to the display device.
